(19) United States
(12) Patent Application Publication
(10) Pub. No.: US 2004/0089512 A1
(43) Pub. Date: May 13, 2004

(54) Method for obtaining a clutch lining, a clutch lining obtained using said method and a clutch disc fitted with one such friction lining

(76) Inventors: Michel Marchisseau, Limoges (FR); Christian Biot, Le Palais Sur Vienne (FR); Gerard Boyer, Saint Priest Taurion (FR)

Correspondence Address: Liniak Berenato & White, Suite 240, 6550 Rock Spring Drive, Bethesda, MD, 20817, US

(21) Appl. No.: 10/275,065

(22) PCT Filed: Mar. 13, 2002
(86) PCT No.: PCT/FR02/00893

(30) Foreign Application Priority Data
Mar. 15, 2001 (FR) 01/03542

(51) Int. Cl. F16D 69/02; B29C 45/26

(52) U.S. Cl. 192/107 M; 264/37.33; 264/161; 264/300; 264/328.2; 264/328.18; 192/70.14

(57) ABSTRACT

The invention relates to a method for obtaining a clutch lining consisting in: injecting a friction material containing a polyester resin into a mould; the material also contains a polymerisation catalyst, glass fibres, chalk, mica, talc, kaolin, thermoplastic fillers and a mould release agent. The invention also relates to a clutch lining obtained using said method and a clutch disc fitted with one such lining.

The invention relates to a friction lining, in particular for clutch discs.

Friction linings for clutch discs can be rings of friction material or consist of annular sectors or studs; they can be fixed directly to a lining-support disc or carried by foils in the form of annular support rings themselves fixed to the lining-support disc. The lining-support disc generally has a peripheral portion divided into two series of radial paddles alternating circumferentially with bearing areas offset axially to obtain progressive clamping of the friction linings.

Friction linings can be fixed by gluing or riveting them.

Linings for clutch discs are usually fabricated by compressing a mixture of fibres, resins and fillers.

A compression fabrication method of the above kind generally comprises operations including preparing the mixture, compression moulding, polymerisation, grinding and drilling in the case of fixing by riveting. The number and the technical diversity of these operations are not favourable for productivity and production flow.

Compression moulding is accompanied by leaking of significant quantities of material. Moreover, the geometrical quality of the clutch friction linings at the end of the compression moulding process is insufficient; this defect is corrected by grinding. Also, when the linings are fixed by riveting, the necessary fixing holes are often obtained by drilling. These three weaknesses are responsible for wastage of the material employed, which can exceed 30%. The scrap friction material is then dumped in landfill, which is not favourable for the environment.

An object of the present invention is to provide a fabrication method that is free of the above drawbacks. According to the invention, the method is an injection method consisting in injecting a friction material into a mould, characterised in that the friction material contains a polyester resin.

The friction material containing a polyester resin is advantageously subjected to compression after it is injected into the mould.

The material containing polyester has a good aptitude for injection. This material has friction qualities allowing the production of clutch linings in which the maximum operating temperatures are lower than those reached by brake linings. The cost of this material is competitive. The parallelism of clutch linings fabricated by injecting material containing polyester is entirely appropriate and it is not necessary to have systematic recourse to grinding operations. The leaks of material during injection moulding are slight; be this as it may, leaks can be recovered and recycled into the injected material. The unit cost of linings obtained by the method according to the invention is very competitive.

Moreover, thanks to this kind of material, the fixing holes are obtained directly from the moulding operation thanks to studs provided in the mould. What is more, if the injection operation is followed by compression, as mentioned above, the geometry of said holes is perfect, thanks to the perfect pressing of the compressed material against the studs.

After the injection phase, the lining is advantageously subjected to a deburring operation; burrs removed by the deburring operation are then recovered, ground and fed back into the material containing the polyester before it is injected into the injection mould.

An insert is preferably introduced into the injection mould before the injection operation.

The injection is advantageously effected via at least one injection point situated in the vicinity of the external periphery of the lining to be obtained.

Studs are preferably provided in the mould to produce fixing holes in the lining.

The material to be injected advantageously contains inorganic and/or organic and/or metal fibres from 1 mm to 30 mm long, unsaturated polyester resin, a polymerisation catalyst and more than 0.4% by weight mould release agent.

The material to be injected preferably contains, by weight:

from 5% to 40% unsaturated polyester resin;

from 0.5% to 2% polyester resin catalyst;

from 0% to 30% heatsetting resins (other than polyester resins), such as, for example, melamine resins or phenolic resins (novolak, resol, CNSL, etc.) or mixed melamine and phenolic resins;

from 0% to 30% organic fibres from 1 mm to 30 mm long, such as, for example, acrylic fibres, carbon fibres, polyamide fibres, cellulose fibres;

from 0% to 40% inorganic fibres from 1 mm to 20 mm long, such as, for example, glass fibres, rock wool fibres, ceramic fibres, basalt fibres, calcium silicate fibres;

from 0% to 30% metal fibres such as, for example, copper fibres, brass fibres, steel fibres, aluminium fibres, zinc fibres;

from 0% to 15% lubricating fillers such as, for example, graphite, antimony trisulphide, talc;

from 0% to 20% conductive powders consisting of metal powders such as, for example, powders of copper and its alloys (brass, bronze, etc.), steel, aluminium, etc., or consisting of carbon black, graphite;

from 0% to 10% abrasive fillers such as, for example, silica, various silicates;

from 0% to 15% fillers to improve fluidity during injection and/or to reduce the final density, such as, for example, glass microspheres (hollow and/or with high surface porosity), ceramic microspheres, fine sawdust;

from 5% to 15% thermoplastic fillers; and

from 0.5% to 5% internal mould release agents.

A typical composition of the material to be injected contains, by weight:

16% unsaturated polyester resin;

0.7% polymerisation catalyst;

28% glass fibres 6 mm long;

20% chalk;

10% mica;

5.5% talc;

10% kaolin;

8% thermoplastics fillers; and

1.8% mould release agent.

The invention also provides a clutch friction lining produced by the above method.

The friction lining advantageously includes an insert; the insert is a metal insert; the insert is made of a composite material.

The insert can be produced with any of the following shapes or any combination thereof: plane annular shape, toroidal shape, spiral shape.

The friction lining advantageously has moulded-in fixing holes.

The disposition of the fibres in at least one section of the lining is advantageously such that for a population of more than 60% of the fibres each fibre belonging to the aforementioned population is oriented in a space defined by a cone whose characteristics are as follows: the angle at the apex is 90°, the axis of symmetry is tangential to the circle centred on the axis of the lining and passes through the intersection of the fibre concerned with the portion of the section concerned, and the apex is at the intersection of the fibre concerned with the portion of the section concerned.

The present invention further provides a clutch disc equipped with a friction lining of the above kind.

To explain the subject matter of the invention more clearly, embodiments shown in the accompanying drawings are described next by way of purely illustrative and non-limiting example.

In the drawings:

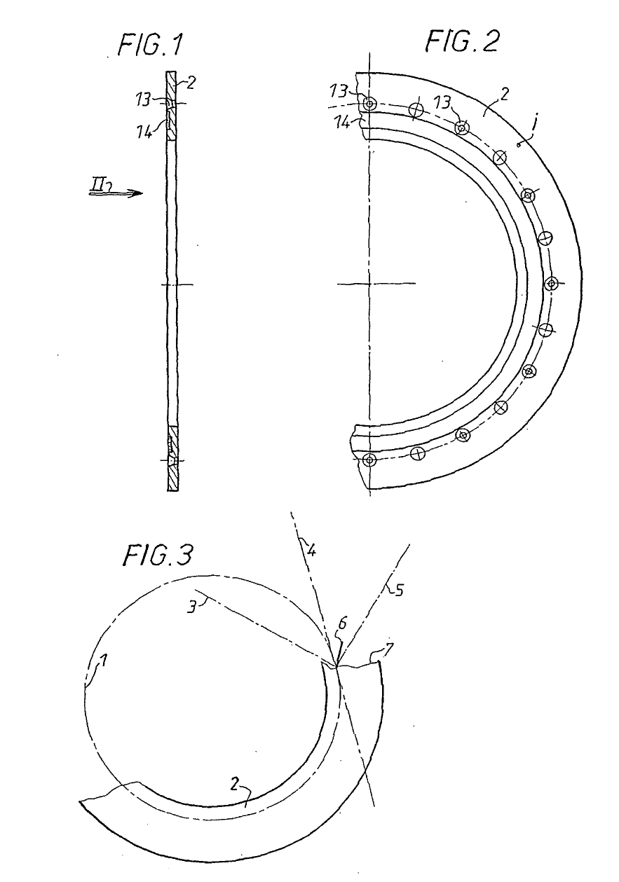

FIG. 1 shows a view in axial section of an annular lining according to the invention;

FIG. 2 is a partial view in the direction of the arrow II in FIG. 1;

FIG. 3 is a partial diagrammatic plan view of an annular lining obtained by the method according to the invention;

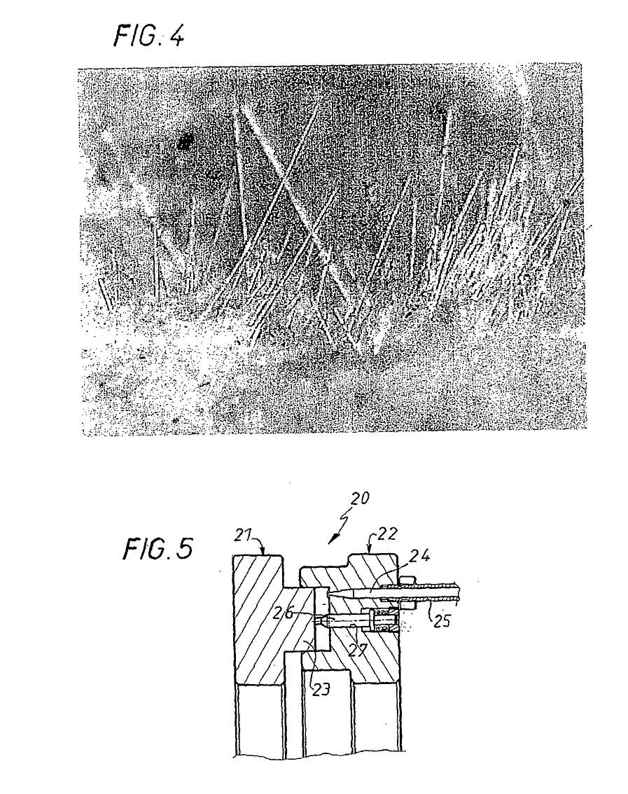

FIG. 4 is a photograph showing to a large scale a view in cross section of a lining according to the invention; and

FIG. 5 is a diagrammatic view in section showing the die of a mould in which injection is followed by compression.

FIGS. 1 and 2 show an annular lining comprising polyester resin, fibres and fillers and obtained by the method according to the invention, i.e. by injection.

The lining comprises:

16% unsaturated polyester resin;

0.7% polymerisation catalyst;

28% glass fibres 6 mm long;

20% chalk;

10% mica;

5.5% talc;

10% kaolin;

8% thermoplastics fillers; and

1.8% mould release agent.

This material has been injected into an annular mould from an injection point that is advantageously in the vicinity of the external circular periphery.

FIGS. 1 and 2 show an annular lining obtained by the method according to the invention.

From this injection inlet, the material flows in a generally annular manner to constitute a lining ring. As a result of this, the disposition of the glass fibres, such as the fibre 6 in FIG. 3, within the lining is highly favourable for good retention thereof during centrifuging; this disposition can be defined as follows (see FIG. 3).

The disposition of the fibre 6 in the section 7 of the clutch lining 2 is oriented inside a cone defined by its generatrices 3 and 5 that intersect with the plane of the figure. The angle at the apex of this cone is 90°. The axis 4 of the cone is tangential to the circle 1 centred on the axis of the clutch lining 2 passing through the intersection of the fibre 6 with the section 7. The apex of the cone is situated at this intersection and the axis 4 of the cone is tangential to the circle 1. More than 60% of the fibres have this kind of disposition; FIG. 4 shows this disposition well.

Of course, the injection point is a singular point; this point is the point I in FIG. 2, for example; as stated above, the material flows in a generally annular manner during the injection operation; however, at the injection point, the material enters in all directions and the disposition of the fibres here is such that they radiate around the point I; this is not very favourable from the point of view of retention during centrifuging, because a good number of the fibres have a globally radial direction or are inclined at less than 90° to the radius of the disc passing through the point I; it is then preferable, as shown in FIG. 2, for the point I to be situated in the vicinity of the external periphery of the lining so that, in the event of centrifuging, only a small portion of lining is detached.

The clutch lining 2 shown in FIGS. 1 and 2 includes an insert 14; this can be made of metal or a composite material, for example as described in the document FR-A-2 760 503. The clutch lining 2 has fixing holes 13. The insert 14 is flush with the fixing face of the lining 2. It is situated inside the diameter on which the fixing holes 13 are located.

In a variant, the friction material containing a polyester resin is compressed after it is injected into the mould; FIG. 5 shows partly in section an example of an injection mould die adapted to subject the injected material to compression; one of the plates 21 and 22 of the die 20, which are movable axially relative to each other, is provided with an annular piston 23 adapted to cooperate with an annular chamber of the other plate; an injection passage 24 fed with material via a pipe 25 discharges into the annular chamber.

FIG. 5 also shows studs 26, here carried by the plate 22, for moulding fixing holes into the lining; the studs 26 are adapted to slide in complementary housings 27 provided in the plate 22 during the compression phase.

1. A method of obtaining a clutch friction lining by injection, consisting in injecting a friction material into a mould, characterised in that the friction material contains a polyester resin.

2. A method according to claim 1, characterised in that the friction material containing a polyester resin is subjected to compression after it is injected into the mould.

3. A method according to claim 1 or claim 2, characterised in that, after the injection phase, the lining is subjected to a deburring operation.

4. A method according to claim 3, characterised in that burrs removed by the deburring operation are recovered, ground and fed back into the material containing the polyester before it is injected into the injection mould.

5. A method according to any of claims 1 to 4, characterised in that an insert is introduced into the injection mould before the injection operation.

6. A method according to any of claims 1 to 5, wherein the injection is effected via at least one injection point, characterised in that the injection point is situated in the vicinity of the external periphery of the lining to be obtained.

7. A method according to any of claims 1 to 6, characterised in that studs are provided in the mould to produce fixing holes in the lining.

8. A method according to any of claims 1 to 7, characterised in that the material to be injected contains inorganic and/or organic and/or metal fibres from 1 mm to 30 mm long, unsaturated polyester resin, a polymerisation catalyst and more than 0.4% by weight mould release agent.

9. A method according to claim 8, characterised in that the material to be injected contains, by weight:
from 5% to 40% unsaturated polyester resin;
from 0.5% to 2% polyester resin catalyst;
from 0% to 30% heatsetting resins (other than polyester resins), such as melamine resins, or phenolic resins (novolak, resol, CNSL, etc.) or mixed melamine and phenolic resins;
from 0% to 30% organic fibres from 1 mm to 20 mm long, such as acrylic fibres, carbon fibres, polyamide fibres, cellulose fibres;
from 0% to 40% inorganic fibres from 1 mm to 20 mm long, such as glass fibres, rock wool fibres, ceramic fibres, basalt fibres, calcium silicate fibres;
from 0% to 30% metal fibres such as copper fibres, brass fibres, steel fibres, aluminium fibres, zinc fibres, etc.;
from 0% to 15% lubricating fillers such as graphite, antimony trisulphide, talc;
from 0% to 20% conductive powders consisting of metal powders such as powders of copper and its alloys (brass, bronze, etc.), steel, aluminium, etc., or consisting of carbon black, graphite, etc.;
from 0% to 10% abrasive fillers such as silica, various silicates;
from 0% to 15% fillers to improve fluidity during injection and/or to reduce the final density, such as glass microspheres (hollow and/or with high surface porosity), ceramic microspheres, fine sawdust;
from 5% to 15% thermoplastic fillers; and
from 0.5% to 5% internal mould release agents.

10. A method according to claim 8, characterised in that the material to be injected contains, by weight:
16% unsaturated polyester resin;
0.7% polymerisation catalyst;
28% glass fibres 6 mm long;
20% chalk;
10% mica;
5.5% talc;
10% kaolin;
8% thermoplastics fillers; and
1.8% mould release agent.

11. A clutch friction lining characterised in that it is obtained by the method according to any of claims 1 to 10.

12. A friction lining according to claim 11, characterised in that it includes an insert.

13. A friction lining according to claim 12, characterised in that the insert is made of metal.

14. A friction lining according to claim 12, characterised in that the insert is made of a composite material.

15. A friction lining according to any of claims 11 to 14, characterised in that it has moulded-in fixing holes.

16. A friction lining according to any of claims 11 to 15, characterised in that the disposition of the fibres in at least one section (7) of the lining (2) is such that for a population of more than 60% of the fibres (6) each fibre (6) belonging to the aforementioned population is oriented in a space defined by a cone whose characteristics are as follows: the angle at the apex is 90°, the axis of symmetry (4) is tangential to the circle (1) centred on the friction lining (2) and passing through the intersection of the fibre (6) concerned with the portion of the section (7) concerned, and the apex is at the intersection of the fibre (6) concerned with the portion of the section (7) concerned.

17. A clutch disc equipped with a friction lining, characterised in that the friction lining is a friction lining according to any of claims 11 to 16.
